(19) United States
(12) Patent Application Publication
(10) Pub. No.: US 2022/0300786 A1
(43) Pub. Date: Sep. 22, 2022

(54) AUDIO-VISUAL ACTIVITY SAFETY RECOMMENDATION WITH CONTEXT-AWARE RISK PROPORTIONAL PERSONALIZED FEEDBACK

(71) Applicant: International Business Machines Corporation, Armonk, NY (US)

(72) Inventors: RAGHAVENDRA Krishna Murthy, Bangalore (IN); Manoj Kumar Goyal, Bangalore (IN); Vijay Ekambaram, Chennai (IN); Smitkumar Narotambhai Marvaniya, Bangalore (IN); Shikhar Kwatra, San Jose, CA (US)

(21) Appl. No.: 17/207,635

(22) Filed: Mar. 20, 2021

(51) Int. Cl. G06N 3/04; G06N 3/08; G16Y 10/75; G08B 21/18; G16Y 40/50

(52) U.S. Cl. CPC G06N 3/0427; G06N 3/0445; G06N 3/08; G16Y 10/75; G08B 21/182; G16Y 40/50

(57) ABSTRACT

Aspects of the present invention disclose a method for selecting a modality to distract a subject from engaging in risk events that minimize disturbances to users within the surrounding of the subject while maximizing an impact of the distraction on the subject. The method includes one or more processors identifying a sequence of actions of a subject within a sensor feed. The method further includes generating a knowledge graph based at least in part on activities of the subject, wherein the knowledge graph includes historical activity data. The method further includes determining that an activity of the subject is hazardous based at least in part on the sequence of actions of the subject. The method further includes initiating a distraction task on an internet of things (IoT) enabled device within a defined area that includes the subject, wherein the distraction task includes an audio-visual event.

### BACKGROUND OF THE INVENTION

The present invention relates generally to the field of Internet-of-Things, and more particularly to safety monitoring of individuals in a physical area.

In computer science, context awareness refers to the idea that computers can both sense and react based on their environment. Devices may have information about the circumstances under which they are able to operate and based on rules, or an intelligent stimulus, react accordingly. Context awareness is regarded as an enabling technology for ubiquitous computing systems. Context-aware systems are concerned with the acquisition of context (e.g., using sensors to perceive a situation), the abstraction and understanding of context (e.g., matching a perceived sensory stimulus to a context), and application behavior based on the recognized context (e.g., triggering actions based on context).

In the context of human-computer interaction, a modality is the classification of a single independent channel of sensory input/output between a computer and a human. A system is designated unimodal if it has only one modality implemented, and multimodal if it has more than one. If multiple modalities are available for a task, the system is said to have redundant modalities. Multiple modalities can be used in combination to provide complementary methods that may be redundant but convey information more effectively.

Seq2seq is a family of machine learning approach that turns one sequence into another sequence. Seq2seq does so by use of a recurrent neural network (RNN) or more often long short-term memory (LSTM) or gated recurrent unit (GRU) to avoid the problem of vanishing gradient. The context for each item is the output from the previous step. The primary components are one encoder and one decoder network. The encoder turns each item into a corresponding hidden vector containing the item and a context of the item. The decoder reverses the process, turning the vector into an output item, using the previous output as the input context.

### SUMMARY

Aspects of the present invention disclose a method, computer program product, and system for selecting a modality to distract a subject from engaging in risk events, that minimizes disturbances to users within the surrounding of the subject, while maximizing an impact of the distraction on the subject. The method includes identifying a sequence of actions of a subject within a sensor feed. The method further includes generating a knowledge graph based at least in part on activities of the subject, wherein the knowledge graph includes historical activity data. The method further includes determining that an activity of the subject is hazardous based at least in part on the sequence of actions of the subject. The method further includes initiating a distraction task on an internet of things (IoT) enabled device within a defined area that includes the subject, wherein the distraction task includes an audio-visual event.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program, within the data processing environment of FIG. 1, for selecting a modality to distract a subject from engaging in risk events that minimize disturbances to users within the surrounding of the subject while maximizing an impact of the distraction on the subject, in accordance with embodiments of the present invention.

FIG. 3 is a diagram depicting an illustration of an architecture of a deep learning (DL) model, in accordance with embodiments of the present invention.

FIG. 4 is a block diagram of components of FIG. 1, in accordance with an embodiment of the present invention.

### DETAILED DESCRIPTION

Embodiments of the present invention allow for modality selection to distract a subject from engaging in risk events, minimize disturbances to users within the surroundings of the subject, while maximizing an impact of the distraction on the subject. Embodiments of the present invention perform activity recognition to determine whether identified actions of a subject are unsafe activities. Additional embodiments of the present invention utilize a context of a physical environment of a subject, subject current state, and risk level of the unsafe activities/object to determine an appropriate distraction for the subject to prevent engagement in the unsafe activities via an internet of things (IoT) environment. Further embodiments of the present invention provide alerts to users within an operating physical environment of a subject to notify the users of an unsafe activity the subject is engaged in.

Some embodiments of the present invention recognize that challenges exist to intelligently identify a context-aware audio-visual activity to engage subjects based on a set of conditions of a physical environment of the subjects, current state of the subjects, level of the risk event/harmful object. For example, a student attempting to grab a dangerous object while a user is attending a web conference via a mobile device. In this example, existing systems can notify the user of the identified action of the student but are not capable of selecting an activity modality that engages the student and does not distract the user. Embodiments of the present invention propose to solve this challenge by utilizing video activity modality analysis and Neuro-Symbolic artificial intelligence (AI) to analyze physical environment context information of a subject and enable an additional safety layer via audio-visual interactions that pose minimal distractions to other users in a physical environment of the subject.

Implementation of embodiments of the invention may take a variety of forms, and exemplary implementation details are discussed subsequently with reference to the Figures.

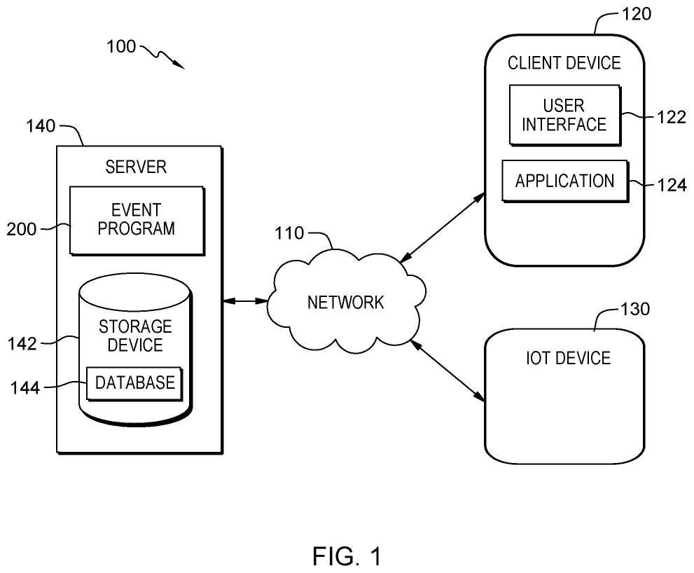

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

The present invention may contain various accessible data sources, such as database 144, client device 120, and IOT device 130, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Event program 200 enables the authorized and secure processing of personal data. Event program 200 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Event program 200 provides information regarding personal data and the nature (e.g., type, scope, purpose, duration, etc.) of the processing. Event program 200 provides the user with copies of stored personal data. Event program 200 allows the correction or completion of incorrect or incomplete personal data. Event program 200 allows the immediate deletion of personal data.

Distributed data processing environment 100 includes server 140, client device 120 and IOT device 130, all interconnected over network 110. Network 110 can be, for example, a telecommunications network, a local area network (LAN) a municipal area network (MAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include voice, data, and video information. In general, network 110 can be any combination of connections and protocols that will support communications between server 140, IOT device 130, and client device 120, and other computing devices (not shown) within distributed data processing environment 100.

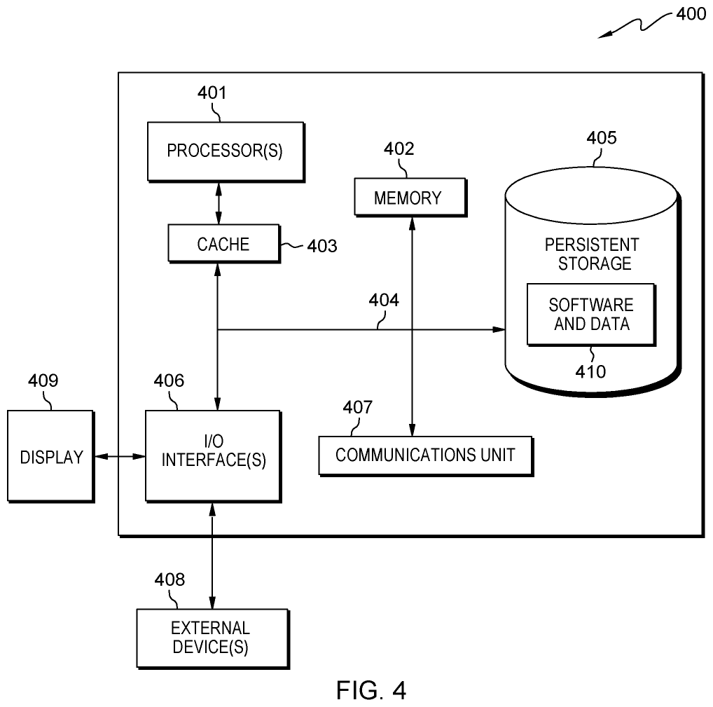

Client device 120 can be one or more of a laptop computer, a tablet computer, a smart phone, smart watch, a smart speaker, virtual assistant, or any programmable electronic device capable of communicating with various components and devices within distributed data processing environment 100, via network 110. In general, client device 120 represents one or more programmable electronic devices or combination of programmable electronic devices capable of executing machine readable program instructions and communicating with other computing devices (not shown) within distributed data processing environment 100 via a network, such as network 110. Client device 120 may include components as depicted and described in further detail with respect to FIG. 4, in accordance with embodiments of the present invention.

Client device 120 includes user interface 122, application 124, and sensor 126. In various embodiments of the present invention, a user interface is a program that provides an interface between a user of a device and a plurality of applications that reside on the client device. A user interface, such as user interface 122, refers to the information (such as graphic, text, and sound) that a program presents to a user, and the control sequences the user employs to control the program. A variety of types of user interfaces exist. In one embodiment, user interface 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 122 is a script or application programming interface (API).

Application 124 is a computer program designed to run on client device 120. An application frequently serves to provide a user with similar services accessed on personal computers (e.g., web browser, playing music, e-mail program, or other media, etc.). In one embodiment, application 124 is mobile application software. For example, mobile application software, or an “app,” is a computer program designed to run on smart phones, tablet computers and other mobile devices. In another embodiment, application 124 is a web user interface (WUI) and can display text, documents, web browser windows, user options, application interfaces, and instructions for operation, and include the information (such as graphic, text, and sound) that a program presents to a user and the control sequences the user employs to control the program. In another embodiment, application 124 is a client-side application of event program 200. In yet another embodiment, application 124 is a VR application that utilizes images of sensor 126 to create an interactive scene corresponding to a defined area of client device 120.

Sensor 126 is a device, module, machine, or subsystem that detects events or changes in an environment of the device and sends the information to other electronics. In one embodiment, sensor 126 represents a variety of sensors of client device 120 that collect and provide various kinds of data. For example, client device 120 utilizes one or more sensors (e.g., a camera, etc.) for capturing images of an operating environment of client device 120.

IoT device(s) 130 can include one or more of a laptop computer, a tablet computer, a smart phone, smart watch, a smart speaker, virtual assistant, kitchen appliance, sensor, or any programmable electronic device capable of communicating with various components and devices within distributed data processing environment 100, via network 110. In general, IoT device(s) 130 represents one or more programmable electronic devices or combination of programmable electronic devices capable of executing machine readable program instructions and communicating with other computing devices (not shown) within distributed data processing environment 100 via a network, such as network 110. For example, IoT device(s) 130 can include wireless sensors, software, actuators, and/or computer devices that are attached to a particular object that operates through the internet, enabling the transfer of data among objects or people automatically without human intervention. IoT device(s) 130 may include components as depicted and described in further detail with respect to FIG. 4, in accordance with embodiments of the present invention.

In various embodiments of the present invention, server 140 may be a desktop computer, a computer server, or any other computer systems, known in the art. In general, server 140 is representative of any electronic device or combination of electronic devices capable of executing computer readable program instructions. Server 140 may include components as depicted and described in further detail with respect to FIG. 4, in accordance with embodiments of the present invention.

Server 140 can be a standalone computing device, a management server, a web server, a mobile computing device, or any other electronic device or computing system capable of receiving, sending, and processing data. In one embodiment, server 140 can represent a server computing system utilizing multiple computers as a server system, such as in a cloud computing environment. In another embodiment, server 140 can be a laptop computer, a tablet computer, a netbook computer, a personal computer (PC), a desktop computer, a personal digital assistant (PDA), a smart phone, or any programmable electronic device capable of communicating with client device 120 and other computing devices (not shown) within distributed data processing environment 100 via network 110. In another embodiment, server 140 represents a computing system utilizing clustered computers and components (e.g., database server computers, application server computers, etc.) that act as a single pool of seamless resources when accessed within distributed data processing environment 100.

Server 140 includes storage device 142, database 144, and event program 200. Storage device 142 can be implemented with any type of storage device, for example, persistent storage 405, which is capable of storing data that may be accessed and utilized by client device 120, IOT device 130, and server 140, such as a database server, a hard disk drive, or a flash memory. In one embodiment storage device 142 can represent multiple storage devices within server 140. In various embodiments of the present invention, storage device 142 stores numerous types of data which may include database 144. Database 144 may represent one or more organized collections of data stored and accessed from server 140. For example, database 144 includes historical data of a user, device usage, user profiles, security rules, etc. In one embodiment, data processing environment 100 can include additional servers (not shown) that host additional information that accessible via network 110.

Generally, event program 200 can identify unsafe events and harmful objects associated with a subject and initiate an audio-visual communication to the subject by auto selecting a modality to deliver activities to the subject using devices of an IoT enabled environment that provides a minimal distraction to a user within a physical environment of the subject. In one embodiment, event program 200 utilizes sensor 126 of client device 120 to identify an activity/event of a subject and/or user. For example, event program 200 utilizes a video feed of a camera (e.g., sensor 126) to identify actions a student (e.g., subject) based on one or more images of the student. In this example, event program 200 utilizes a machine learning algorithm to represent actions of the images of the student and objects the student is interacting with. Additionally, event program 200 uses the above methodologies to identify actions of a teacher (e.g., user) in a classroom (e.g., physical environment) with the student. Alternatively, event program 200 utilizes activity modality techniques (e.g., keyboards, touchscreens, computer vision, speech recognition, etc.) identify the activities of the teacher in the classroom.

In another embodiment, event program 200 utilizes data of IOT device 130 to identify one or more computer-human modalities. For example, event program 200 identifies one or more distraction modalities, which can create sensory outputs that can distract a student based on IoT enabled devices (e.g., IOT device 130) within a classroom (e.g., physical environment) of the student. In this example, event program 200 transmits a query to devices connected to a WLAN to identify the one or more IoT enabled device with a modality (e.g., haptics, audio, video, or any other sensory sources) to distract the student.

In yet another embodiment, event program 200 utilizes a machine learning algorithm to generate and transmit an interactive activity to a subject using IOT device 130. For example, event program 200 can sort identified distraction modalities based at least in part on a disturbance score with the physical environment, an effectiveness score with a student, and/or a responsiveness score with the student. Also, various aggregation methods such as weighted average, linear average, or any domain specific averaging method can be applied. In this example, event program 200 renders a distraction modality to the student such that the disturbance to a teacher in the physical environment is minimized and the impact of the distraction on the student is maximized. Additionally, event program 200 captures feedback of the student to the rendered distraction modality and injects positive or negative rewards to continuously model the effectiveness and responsiveness score of various distractions using reinforcement learning techniques.

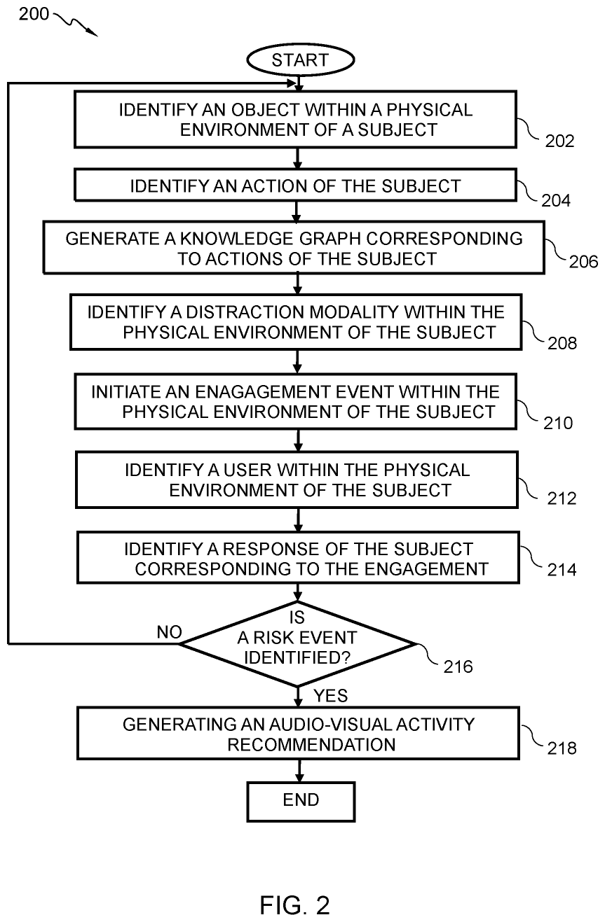

FIG. 2 is a flowchart depicting operational steps of event program 200, a program that selects a modality to distract a subject from engaging in risk events, that minimizes disturbances to users within the surrounding of the subject while maximizing an impact of the distraction on the subject, in accordance with embodiments of the present invention. In one embodiment, event program 200 initiates in response to a user connecting client device 120 to event program 200 through network 110. For example, event program 200 initiates in response to a user registering (e.g., opting-in) a CCTV camera (e.g., client device 120) with event program 200 via a WLAN (e.g., network 110). In another embodiment, event program 200 is a background application that continuously monitors client device 120. For example, event program 200 is a client-side application (e.g., application 124) that initiates upon booting of a mobile device (e.g., client device 120) of a user.

In various embodiments of the present invention, event program 200 utilizes deep structured learning techniques based on artificial neural networks with representation learning, which can be supervised, semi-supervised or unsupervised, to perform human action recognition tasks. The deep-learning architectures, such as deep neural networks, deep belief networks, recurrent neural networks, and convolutional neural networks, can be applied to perform tasks. Event program 200 pretrains the machine learning models based on historical data modeling using seq2seq modeling.

In step 202, event program 200 identifies an object within a physical environment of a subject. In one embodiment, event program 200 utilizes video data of sensor 126 of client device 120 to identify objects within a physical environment of a subject. For example, event program 200 inputs a video feed of a camera (e.g., client device 120) within a classroom (e.g., physical environment, defined area, etc.) into a machine learning algorithm to identify one or more items (e.g., object) that a student can interact with within the classroom. In this example, event program 200 can use a pretrained convolutional neural networks (CNNs) (e.g., machine learning algorithm) to identify an item. Also, event program 200 can determine whether the identified item presents a safety risk to the student based on a classification (e.g., safe, dangerous, hazardous, etc.) of the item.

In step 204, event program 200 identifies an action of the subject. In one embodiment, event program 200 utilizes video data of sensor 126 of client device 120 to identify actions of a subject. For example, event program 200 inputs a video feed of a camera (e.g., client device 120) within a classroom (e.g., physical environment) into a machine learning algorithm to identify actions of a student (e.g., subject). In this example, event program 200 use a CNN (e.g., machine learning algorithm) with spatio-temporal three-dimensional (3D) kernels (3D CNNs) to extract spatio-temporal features from the video feed for action recognition tasks corresponding to the student (i.e., 3D CNNs based on residual networks (ResNets) architecture, which are designed to enable hundreds or thousands of convolutional layers, are used for action representation).

In another embodiment, event program 200 utilizes video data of sensor 126 of client device 120 to predict an action sequence a subject. For example, event program 200 utilizes a trained encoder-decoder neural architecture that takes a sequence of video frames from a video feed of a camera (e.g., client device 120) that includes identified items (e.g., objects) using context-aware video sequence representation of a CNN with 3D kernels to predict based on historical modeling a sequence of video frames corresponding to a future action event of a student (e.g., subject). In this example, event program 200 also determines a risk level estimation for the future activity by utilizing multi-task learning (MTL) techniques where two different loss functions (e.g., loss functions for activity identification and risk level estimation) are used based on the CNN with 3D kernels.

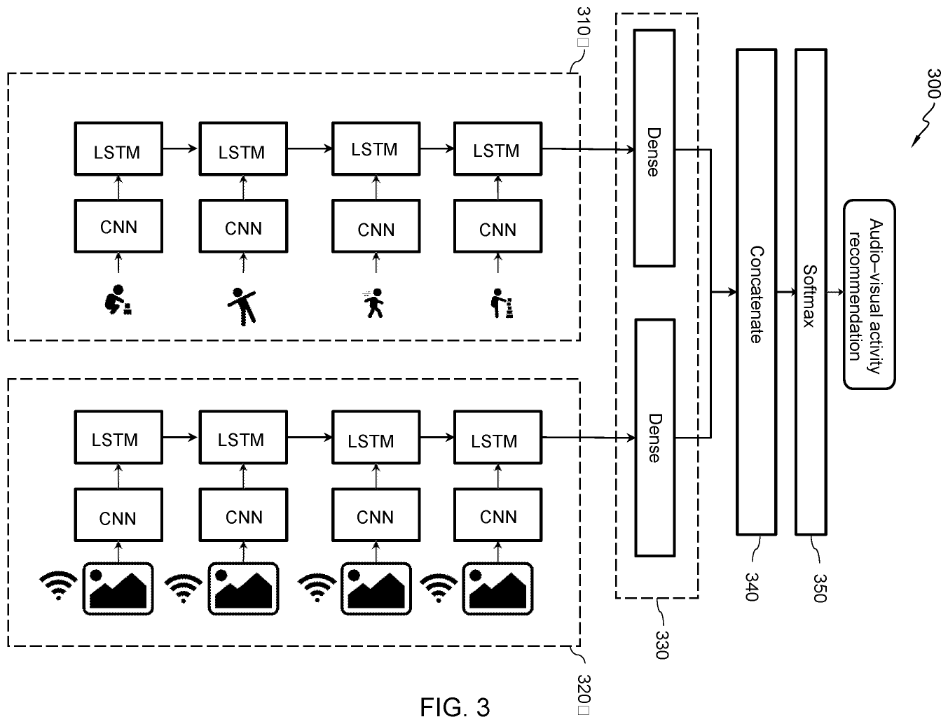

FIG. 3 depicts multi-modality model 300, which is an example illustration of an architecture of a deep learning (DL) model that event program 200 utilizes, in accordance with example embodiments of the present invention. Multi-modality model 300 includes subject RNN 310, user RNN 320, dense layer 330, attention layer 340, and neural network 350. RNN 310 is a recurrent neural network (RNN) that identifies an action of a student in a video feed based on a sequence of frames of the video feed and determines a risk level of the action. RNN 320 is a recurrent neural network (RNN) that utilizes sensor feeds of IOT device 130 and client device 120 to identifies an action of a user within a physical environment of the student and determines a disturbance level of the user based on an audio-visual event corresponding to the student. Dense layer 330 includes at least two separate layers that are utilized to represent a compact embedding representation of an output of RNN 310 and RNN 320. Attention layer 340 is a seq2seq model that turns one sequence into another sequence with an attention optimization that allows a decoder to look at the input sequence selectively that concatenates extracted features. Neural network 350 is a classifier that performs aggregation methods such as weighted average, linear average, or any domain specific averaging method to output a score for each identified distraction modality within the physical environment. In an example embodiment, event program 200 inputs video feed of a camera (e.g., client device 120) into RNN 310 to identify an action of a subject, objects within a physical environment of the subject, and determine a risk level of the identified action. Also, event program 200 inputs a sensor feed (e.g., IOT device 130) of the physical environment into RNN 320 to identify actions of a user.

In step 206, event program 200 generates a knowledge graph corresponding to actions of the subject. In one embodiment, event program 200 structures database 144 to correspond to actions of a subject. For example, event program 200 constructs a knowledge graph (e.g., database document) in graph database (e.g., database 144) that corresponds to spatio-temporal interactions of a student (e.g., subject) and a set of items (e.g., object) within a physical environment. In this example, event program 200 inserts a node for an action of the student or interaction with an item of the set of items. Edges between nodes represent the action or interaction related details. Additionally, event program 200 updates nodes and edges of the knowledge graph when as a risk event is identified, which automatically improves the knowledge graph. Also, event program 200 creates a set of metadata/attributes such as object-subject relationships, subject interaction frequency, subject distance from risk object/events corresponding to an identified set of objects within a physical environment of the subject.

In step 208, event program 200 identifies a distraction modality within the physical environment of the subject. In one embodiment, event program 200 utilizes network 110 to identify a set of computer-human modalities of one or more instances of IOT device 130 within a physical environment of a subject. For example, event program 200 transmits a query via a WLAN (e.g., network 110) to IoT enabled devices (e.g., IOT device 130) to identify distraction modality capabilities of each of the IoT enabled devices within a physical environment of a student (e.g., subject). Available distraction modalities can include vision, audition, haptics, or any other sensory sources, etc. Alternatively, event program 200 can generate a log of available distraction modalities when a user registers (e.g., opt-in) an IoT enabled device and allow event program 200 to utilize location data of the registered IoT enabled device.

In step 210, event program 200 initiates an engagement event within the physical environment of the subject. In one embodiment, event program 200 initiates a distraction task on IOT device 130. For example, event program 200 triggers an IoT enabled device such as a virtual assistant or smart lamp to perform an audio-visual event within a physical environment of a student (e.g., subject). In this example, event program 200 utilizes a risk level of a sequence of actions (e.g., current state of the subject) of the student (e.g., running, risk event, etc.) and a generated knowledge graph to select the audio-visual event to execute in the physical environment of the student. Additionally, event program 200 utilizes the generated knowledge graph to identify a relationship between an item (e.g., a sharp pencil) and the risk level of the sequence of actions, which enable performance of a set of audio-visual events. As a result of a notification that includes an audio-visual task request of event program 200, the IoT enabled device can perform actions such as turn lights off and on, enable the display of various colors of light, play television programs and/or musical songs, etc.

In step 212, event program 200 identifies a user within the physical environment of the subject. In one embodiment, event program 200 utilizes client device 120 and/or TOT device 130 to identify a set of conditions within a physical environment of a subject. For example, event program 200 utilizes a video feed of a camera (e.g., client device 120) or one or more IoT enabled devices (e.g., client device 130) to identify a person (e.g., a user) within a classroom (e.g., physical environment) of a student (e.g., subject). In this example, event program 200 inputs the sensor feed of the one or more IoT enabled devices within a classroom into a machine learning algorithm to identify a set of conditions (e.g., context) of the classroom. Additionally, event program 200 use a CNN (e.g., machine learning algorithm) with spatio-temporal three-dimensional (3D) kernels (3D CNNs) to extract spatio-temporal features from the sensor feed for action recognition tasks corresponding to one or more users within the classroom (i.e., event program identifies the presence of user and actions a user is performing within the physical environment). In another example, event program 200 determines action of a teacher (e.g., user) by passive monitoring of a sensor feed of wearable devices (e.g., IOT device 130) of the teacher. In this example, event program 200 utilizes the sensor feed to determine a reaction (e.g., actions, movement, etc.) of the teacher to an audio-visual event within a physical environment of a student (e.g., subject).

Referring now to FIG. 3, in the example embodiment, event program 200 inputs sensor feeds of IoT enabled devices (e.g., IOT device 130) into RNN 320 to identify the presence of a user within a physical environment of a subject and determine actions/interaction of the user. Also, event program 200 inputs a sensor feed (e.g., IOT device 130) of the physical environment into RNN 320 to identify actions of a user. In this example embodiment, event program 200 inputs the output of RNN 320 into a layer of dense layer 330.

In step 214, event program 200 identifies a response of the subject corresponding to the engagement event. In one embodiment, event program 200 identifies a response of a subject to a distraction task of IOT device 130. For example, event program 200 triggers performance of an audio-visual event by an IoT enabled device (e.g., IOT device 130) such as a virtual assistant or smart lamp to avert actions of a student (e.g., subject). In this example, event program 200 inputs a video data feed of the subject into a machine learning algorithm (e.g., support vector machine) to identify actions of the subject in response to the audio-visual event. Additionally, event program 200 utilizes reinforcement techniques to calibrate audio-visual event recommendations based on an engagement level (e.g., interaction, deviation from current sequence of actions, etc.) of the student with the audio-visual event. Alternatively, event program 200 determine a responsiveness score of the audio-visual event based on a deviation in a sequence of actions by the student as compared to a sequence of actions corresponding to a risk event of a generated knowledge graph of the student.

In another embodiment, event program 200 identifies a response of a user to the distraction task of IOT device 130. For example, event program 200 triggers performance of the audio-visual event by the IoT enabled device such as a virtual assistant or smart lamp to avert actions of the student. In this example, event program 200 inputs the video data feed or sensor feed of IoT enabled devices of a teacher (e.g., user) present in the classroom into a machine learning algorithm to identify actions of the teacher in response to the audio-visual event for the student. Additionally, event program 200 utilizes reinforcement techniques to calibrate audio-visual event recommendations based on a distraction level (e.g., deviation from current sequence of actions) of the teacher due to the audio-visual event. Alternatively, event program 200 determines a distraction score of the audio-visual event based on a deviation in a sequence of actions by the teacher.

In decision step 216, event program 200 determines whether a risk event is identified. In one embodiment, event program 200 utilizes sensor 126 of client device 120 and database 144 to determine whether an activity of a subject corresponds to a risk event. For example, event program 200 identifies a sequence of actions corresponding to a hazardous activity (e.g., risk event) in a knowledge graph database that corresponds to a current state (e.g., a sequence of identified actions of a subject in a video data feed) of a student (e.g., subject). In this example, event program 200 identifies an item (e.g., object) and determines that actions of the student indicate an activity of the student includes an interaction with the item. Additionally, event program 200 utilizes the item and actions of the student to determine whether the activity of the student corresponds to the hazardous activity (i.e., automatically stimulating audio-visual interaction between a distraction modality and a subject based on a set of conditions of a physical environment of the subject using a recommended interactive activity for current state (e.g., activity) of the subject).

In another embodiment, if event program 200 determines that an activity of a subject does not corresponds to a risk event of database 144 (decision step 216, “NO” branch), then event program 200 continues to identify objects within a physical environment of the subject as discussed above in step 202. For example, if event program 200 identifies an item (e.g., pencil) and sequence of actions of the student indicate an activity (e.g., sitting and writing) of the student and determines that an interaction with the item does not correlate with a hazardous activity of a knowledge base (e.g., database 144), then event program 200 continues to utilize a camera (e.g., client device 120) to identify actions and objects of the student.

In another embodiment, if event program 200 determines that an activity of a subject corresponds to a risk event of database 144 (decision step 216, “YES” branch), then event program 200 generates an audio-visual activity recommendation. For example, if event program 200 identifies an item (e.g., pencil) and sequence of actions of the student indicate an activity (e.g., running with pencil) of the student and determines that an interaction with the item correlates with a hazardous activity (e.g., risk event) of a knowledge graph (e.g., database 144), then event program 200 generates an audio-visual event for the student in the classroom.

In step 218, event program 200 generates an audio-visual activity recommendation. In one embodiment, event program 200 transmits a request to perform a distraction task to IOT device 130. For example, event program 200 utilizes a knowledge graph (e.g., database 144) to determine a risk level (e.g., score) associated with a hazard activity of a student (e.g., subject) and selects a smart lamp (e.g., IOT device 130) capable of performing a distraction modality corresponding to the risk level. In this example, event program 200 can utilize an attention-based classifier/regressor, distraction score, and a responsiveness score to determine whether a selected distraction modality (e.g., smart lamp) is effective in maximizing the responsiveness of the audio-visual event (e.g., flashing light, color change, etc.) on the student and minimizing the distraction on a teacher (e.g., user) while effectively deterring the student from engaging in an activity (e.g., present or future). Additionally, event program 200 transmits a request that includes the audio-visual event to the smart lamp.

In another embodiment, event program 200 transmits a notification to an instance of IOT device 130 corresponding to a user. In one scenario, if event program 200 determines that a risk level of a hazardous activity is above a predefined threshold (e.g., very high risk of serious injury), then event program 200 transmits a notification to smart watch (e.g., IOT device 130) of a teacher (e.g., user) in addition to delivering an audio-visual event.

Referring now to FIG. 3, in the example embodiment, event program 200 feeds the outputs of the separate layers of dense layer 330 into attention layer 340 that concatenates the extracted features of RNN 310 and RNN 320 to get multiscale maximal features from input images of video feeds of client device 120 and IOT device 130. Additionally, event program 200 passes the output of attention layer 340 into neural network 350 to sort/rank distraction modalities available in the physical environment of the subject. Furthermore, event program 200 selects the top ranked distraction modality to generate an audio-visual event request to be performed by IOT device 130.

FIG. 4 depicts a block diagram 400, of components of client device 120, IOT device 130, and server 140, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data 410) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 410 can be stored in persistent storage 405 for access and/or execution by one or more of the respective processor(s) 401 via cache 403. With respect to client device 120, software and data 410 includes data of user interface 122, application 124 and sensor 126. With respect to server 140, software and data 410 includes data of storage device 142 and event program 200.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., software and data 410) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., software and data 410) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method comprising:
identifying, by one or more processors, a sequence of actions of a subject within a sensor feed;
generating, by the one or more processors, a knowledge graph based at least in part on activities of the subject, wherein the knowledge graph includes historical activity data;
determining, by the one or more processors, that an activity of the subject is hazardous based at least in part on the sequence of actions of the subject; and
initiating, by the one or more processors, a distraction task on an internet of things (IoT) enabled device within a defined area that includes the subject, wherein the distraction task includes an audio-visual event.

2. The computer implemented method of claim 1, further comprising:
identifying, by the one or more processors, a distraction modality within the defined area; and
determining, by the one or more processors, one or more capabilities of the identified distraction modality.

3. The computer implemented method of claim 1, further comprising:
identifying, by the one or more processors, an object within the defined area;
determining, by the one or more processors, a set of attributes of the identified object; and
determining, by the one or more processors, a relationship between the identified object and the subject based at least in part on the sequence of actions of the subject.

4. The computer implemented method of claim 1, further comprising:
determining, by the one or more processors, a set of conditions corresponding to a user within the defined area, wherein the set of conditions correspond to actions of the user; and
identifying, by the one or more processors, a response of the user to the audio-visual event.

5. The computer implemented method of claim 4, further comprising:
generating, by the one or more processors, a distraction modality recommendation based on the response of the user to the audio-visual event.

6. The computer implemented method of claim 1, wherein determining that the activity of the subject is hazardous based at least in part on the sequence of actions of the subject, further comprises:
inputting, by the one or more processors, a video feed that includes the sequence of actions of the subject into a machine learning model;
identifying, by the one or more processors, the activity corresponding to the sequence of actions of the subject based at least in part on an output of the machine learning model and historical user activities; and
determining, by the one or more processors, a risk level corresponding to the activity of the subject.

7. The computer implemented method of claim 6, further comprising:
in response to determining that the risk level corresponding to the activity of the subject exceeds a defined threshold, transmitting, by the one or more processors, a notification to a computing device of the user, wherein the notification includes an alert of the activity of the subject.

8. A computer program comprising:
one or more computer readable storage media and program instructions stored on the one or more computer readable storage media, the program instructions comprising:
program instructions to identify a sequence of actions of a subject within a sensor feed;
program instructions to generate a knowledge graph based at least in part on activities of the subject, wherein the knowledge graph includes historical activity data;
program instructions to determine that an activity of the subject is hazardous based at least in part on the sequence of actions of the subject; and
program instructions to initiate a distraction task on an internet of things (IoT) enabled device within a defined area that includes the subject, wherein the distraction task includes an audio-visual event.

9. The computer program product of claim 8, further comprising program instructions, stored on the one or more computer readable storage media, to:
identify a distraction modality within the defined area; and
determine one or more capabilities of the identified distraction modality.

10. The computer program product of claim 8, further comprising program instructions, stored on the one or more computer readable storage media, to:
identify an object within the defined area;
determine a set of attributes of the identified object; and
determine a relationship between the identified object and the subject based at least in part on the sequence of actions of the subject.

11. The computer program product of claim 8, further comprising program instructions, stored on the one or more computer readable storage media, to:
determine a set of conditions corresponding to a user within the defined area, wherein the set of conditions correspond to actions of the user; and
identify a response of the user to the audio-visual event.

12. The computer program product of claim 11, further comprising program instructions, stored on the one or more computer readable storage media, to:
generate a distraction modality recommendation based on the response of the user to the audio-visual event.

13. The computer program product of claim 8, wherein determining that the activity of the subject is hazardous based at least in part on the sequence of actions of the subject, further comprise program instructions to:
input a video feed that includes the sequence of actions of the subject into a machine learning model;
identify the activity corresponding to the sequence of actions of the subject based at least in part on an output of the machine learning model and historical user activities; and
determine a risk level corresponding to the activity of the subject.

14. The computer program product of claim 13, further comprising program instructions, stored on the one or more computer readable storage media, to:
in response to determining that the risk level corresponding to the activity of the subject exceeds a defined threshold, transmit a notification to a computing device of the user, wherein the notification includes an alert of the activity of the subject.

15. A computer system:
one or more computer processors;
one or more computer readable storage media; and
program instructions stored on the computer readable storage media for execution by at least one of the one or more processors, the program instructions comprising:
program instructions to identify a sequence of actions of a subject within a sensor feed;
program instructions to generate a knowledge graph based at least in part on activities of the subject, wherein the knowledge graph includes historical activity data;
program instructions to determine that an activity of the subject is hazardous based at least in part on the sequence of actions of the subject; and
program instructions to initiate a distraction task on an internet of things (IoT) enabled device within a defined area that includes the subject, wherein the distraction task includes an audio-visual event.

16. The computer system of claim 15, further comprising program instructions, stored on the one or more computer readable storage media for execution by at least one of the one or more processors, to:
identify a distraction modality within the defined area; and
determine one or more capabilities of the identified distraction modality.

17. The computer system of claim 15, further comprising program instructions, stored on the one or more computer readable storage media for execution by at least one of the one or more processors, to:
identify an object within the defined area;
determine a set of attributes of the identified object; and
determine a relationship between the identified object and the subject based at least in part on the sequence of actions of the subject.

18. The computer system of claim 17, further comprising program instructions, stored on the one or more computer readable storage media for execution by at least one of the one or more processors, to:
generate a distraction modality recommendation based on the response of the user to the audio-visual event.

19. The computer system of claim 15, wherein determining that the activity of the subject is hazardous based at least in part on the sequence of actions of the subject, further comprise program instructions to:
input a video feed that includes the sequence of actions of the subject into a machine learning model;
identify the activity corresponding to the sequence of actions of the subject based at least in part on an output of the machine learning model and historical user activities; and
determine a risk level corresponding to the activity of the subject.

20. The computer system of claim 19, further comprising program instructions, stored on the one or more computer readable storage media for execution by at least one of the one or more processors, to:
in response to determining that the risk level corresponding to the activity of the subject exceeds a defined threshold, transmit a notification to a computing device of the user, wherein the notification includes an alert of the activity of the subject.
